(19) United States
(12) Patent Application Publication
(10) Pub. No.: US 2025/0318475 A1
(43) Pub. Date: Oct. 16, 2025

(54) WORKING MACHINE

(71) Applicant: MAKITA CORPORATION, Anjo-shi (JP)

(72) Inventor: Kazuya KATO, Anjo-shi (JP)

(73) Assignee: MAKITA CORPORATION, Anjo-shi (JP)

(21) Appl. No.: 19/092,587

(22) Filed: Mar. 27, 2025

(30) Foreign Application Priority Data
Apr. 12, 2024 (JP) 2024-064593

(51) Int. Cl. A01G 3/037

(52) U.S. Cl. CPC A01G 3/037

(57) ABSTRACT

A working machine may include a prime mover, a power transmission, a working part, and a housing. The power transmission may include a first planetary gear mechanism, a bevel gear, a first bearing, and a second bearing. The bevel gear may include a gear portion and a shaft portion. The first planetary gear mechanism may include a first carrier integrally rotatable with the shaft portion, a first planetary gear rotatably supported by the first carrier, a first internal gear arranged outward of the first planetary gear, and a first sun gear arranged inward of the first planetary gear. The first bearing may be directly or indirectly supported by the housing and support the shaft portion such that the shaft portion is rotatable. The second bearing may be directly or indirectly supported by the housing and support the first carrier such that the first carrier is rotatable.

### REFERENCE TO RELATED APPLICATIONS

This application claims priority to Japanese Patent Application No. 2024-064593 filed on Apr. 12, 2024. The entire content of the priority application is incorporated herein by reference.

### TECHNICAL FIELD

The art disclosed herein relates to a working machine.

### BACKGROUND ART

Chinese Utility Model Registration No. 209954711 describes a working machine. This working machine includes a prime mover, a power transmission connected to the prime mover, a working part connected to the power transmission, and a housing that houses the prime mover and the power transmission. The power transmission includes a first planetary gear mechanism, a bevel gear, a first bearing, and a second bearing. The bevel gear includes a gear portion connected to the working part and a shaft portion integrally rotatable with the gear portion. The first planetary gear mechanism includes a first carrier fixed to the shaft portion, a first planetary gear rotatably supported by the first carrier, a first internal gear arranged outward of the first planetary gear to mesh with the first planetary gear, and a first sun gear arranged inward of the first planetary gear to mesh with the first planetary gear. The first bearing is directly or indirectly supported by the housing and supports the shaft portion such that the shaft portion is rotatable. The second bearing is directly or indirectly supported by the housing and supports the shaft portion such that the shaft portion is rotatable.

### SUMMARY

In working machines as the one described above, a force is applied to the gear portion of the bevel gear in a predetermined direction due to a reaction force the working part receives from a workpiece. Upon the application of the force, the shaft portion of the bevel gear is tilted in the opposite direction to the predetermined direction, with the first bearing and the second bearing as a fulcrum point. As a result, the first carrier is displaced in a direction orthogonal to its rotation axis, thereby causing the first planetary gear to unevenly contact the first sun gear and/or the first internal gear. The disclosure herein provides a technology that prevents a first planetary gear from unevenly contacting a first sun gear and/or a first internal gear.

A working machine disclosed herein may comprise a prime mover, a power transmission connected to the prime mover, a working part connected to the power transmission, and a housing that houses the power transmission. The power transmission may comprise a first planetary gear mechanism, a bevel gear, a first bearing, and a second bearing. The bevel gear may comprise a gear portion connected to the working part and a shaft portion integrally rotatable with the gear portion. The first planetary gear mechanism may comprise a first carrier integrally rotatable with the shaft portion, a first planetary gear rotatably supported by the first carrier, a first internal gear arranged outward of the first planetary gear to mesh with the first planetary gear, and a first sun gear arranged inward of the first planetary gear to mesh with the first planetary gear. The first bearing may be directly or indirectly supported by the housing and support the shaft portion such that the shaft portion is rotatable. The second bearing may be directly or indirectly supported by the housing and support the first carrier such that the first carrier is rotatable.

In the configuration above, the second bearing holds the first carrier not to be displaced in a direction orthogonal to the rotation axis. Therefore, even when a force is applied to the gear portion of the bevel gear in a predetermined direction due to a reaction force the working part receives from a workpiece, it is possible to prevent the shaft portion of the bevel gear from being tilted in the opposite direction to the predetermined direction with the first bearing as a fulcrum point. The configuration above thus can prevent the first planetary gear from unevenly contacting the first sun gear and/or the first internal gear.

### BRIEF DESCRIPTION OF DRAWINGS

FIG. 1 is a perspective view of a working machine 2 according to an embodiment.

FIG. 2 is a right side view of an internal structure in a rear portion of the working machine 2 according to the embodiment.

FIG. 3 is a top cross-sectional view of the working machine 2 according to the embodiment in the vicinity of a power transmission 36.

FIG. 4 is a right side view of an internal structure in a front portion of the working machine 2 according to the embodiment.

FIG. 5 is a top cross-sectional view of a working machine 2 according to a comparative example in the vicinity of a power transmission 36.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved working machines.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a working machine may comprise a prime mover, a power transmission connected to the prime mover, a working part connected to the power transmission, and a housing that houses the power transmission. The power transmission may comprise a first planetary gear mechanism, a bevel gear, a first bearing, and a second bearing. The bevel gear may comprise a gear portion connected to the working part and a shaft portion integrally rotatable with the gear portion. The first planetary gear mechanism may comprise a first carrier integrally rotatable with the shaft portion, a first planetary gear rotatably supported by the first carrier, a first internal gear arranged outward of the first planetary gear to mesh with the first planetary gear, and a first sun gear arranged inward of the first planetary gear to mesh with the first planetary gear. The first bearing may be directly or indirectly supported by the housing and support the shaft portion such that the shaft portion is rotatable. The second bearing may be directly or indirectly supported by the housing and support the first carrier such that the first carrier is rotatable.

In one or more embodiments, the first internal gear may be fixed to the housing.

The configuration above allows the first planetary gear mechanism to function as a rotation reducer with a large reduction ratio.

In one or more embodiments, the first planetary gear mechanism may further comprise a sleeve formed integrally with the first internal gear. The second bearing may be directly supported by the sleeve.

The configuration above allows for simplification of the support structure for the second bearing.

In one or more embodiments, the sleeve may contact the first bearing in a direction of a central axis of the first bearing.

The configuration above allows the sleeve, which is integrally formed with the first internal gear, to function as a retainer for the first bearing and thus allows for simplification of the support structure for the first bearing.

In one or more embodiments, the power transmission may further comprise a second planetary gear mechanism. The second planetary gear mechanism may comprise a second carrier integrally rotatable with the first sun gear, a second planetary gear rotatably supported by the second carrier, a second internal gear arranged outward of the second planetary gear to mesh with the second planetary gear, and a second sun gear arranged inward of the second planetary gear to mesh with the second planetary gear.

The configuration above allows for a rotation reduction in each of the first planetary gear mechanism and the second planetary gear mechanism.

In one or more embodiments, the second internal gear may be a separate component from the first internal gear.

The first and second planetary gear mechanisms are different from each other in the rotating speed and torque inputted thereto, the reduction ratio to be achieved, etc., and thus the first and second internal gears are different from each other in the required strength and rigidity. The above configuration allows the first and second internal gears to be formed from suitable materials and suitably sized to achieve required strengths and rigidities since these internal gears are separate components.

In one or more embodiments, the working part may comprise a first blade and a second blade movable relative to the first blade between an open position and a closed position. The working machine may function as handheld pruning shears.

The configuration above prevents the first planetary gear from unevenly contacting the first sun gear and/or the first internal gear in the working machine that functions as pruning shears.

In one or more embodiments, the prime mover may comprise an electric motor.

The configuration above prevents the first planetary gear from unevenly contacting the first sun gear and/or the first internal gear in the working machine that actuates the working part by an electric motor.

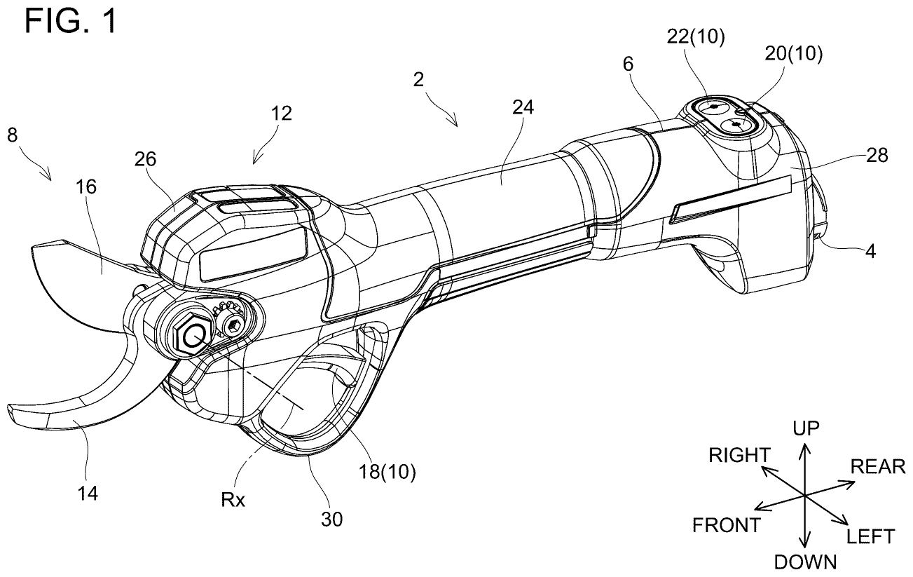

(Embodiment) A working machine 2 shown in FIG. 1 is pruning shears used mainly to cut tree branches, etc. The working machine 2 is an electrically powered working machine that operates with electric power supplied from an external power supply (not shown) through a power connector 4. The working machine 2 is configured such that it can be carried by a user with one hand.

The working machine 2 comprises a housing 6, a working part 8 configured to perform cutting work, a manipulatable part 10 manipulatable by the user, and a display part 12 configured to display various information to the user. The working part 8 comprises a fixed blade 14 and a movable blade 16 rotatable relative to the fixed blade 14. The manipulatable part 10 comprises a trigger lever 18, a power switch 20, and an open position adjusting switch 22. The working machine 2 rotates the movable blade 16 relative to the fixed blade 14 in response to a pulling operation on the trigger lever 18. The housing 6 comprises a grip 24 configured to be gripped by the user with one hand, a front housing portion 26 located forward of the grip 24, a rear housing portion 28 located rearward of the grip 24, and a protection portion 30 configured to protect user's finger(s) placed on the trigger lever 18. The trigger lever 18 and the protection portion 30 are located on a lower portion of the front housing portion 26.

In the disclosure herein, the longitudinal direction of the grip 24 is defined as a front-rear direction. Regarding the front-rear direction, a direction from the grip 24 toward the working part 8 is defined as a front direction (forward), and the opposite direction is defined as a rear direction (rearward). Further, a direction that is orthogonal to the front-rear direction and along a rotation axis Rx of the movable blade 16 is defined as a right-left direction. Regarding the right-left direction, a direction from the movable blade 16 toward the fixed blade 14 is defined as a left direction (leftward), and the opposite direction is defined as a right direction (rightward). Moreover, a direction orthogonal to the front-rear direction and the right-left direction is defined as an up-down direction. Regarding the up-down direction, a direction from the protection portion 30 toward the trigger lever 18 is defined as an up direction (upward), and the opposite direction is defined as a down direction (downward).

The power switch 20 and the open position adjusting switch 22 are located on the upper surface of the rear housing portion 28. The power switch 20 is for switching on/off of the main power of the working machine 2. The open position adjusting switch 22 is for adjusting an open position of the movable blade 16. The display part 12 is located on the upper surface of the front housing portion 26. The display part 12 comprises LED(s) (not shown) for displaying on/off state of the main power, etc.

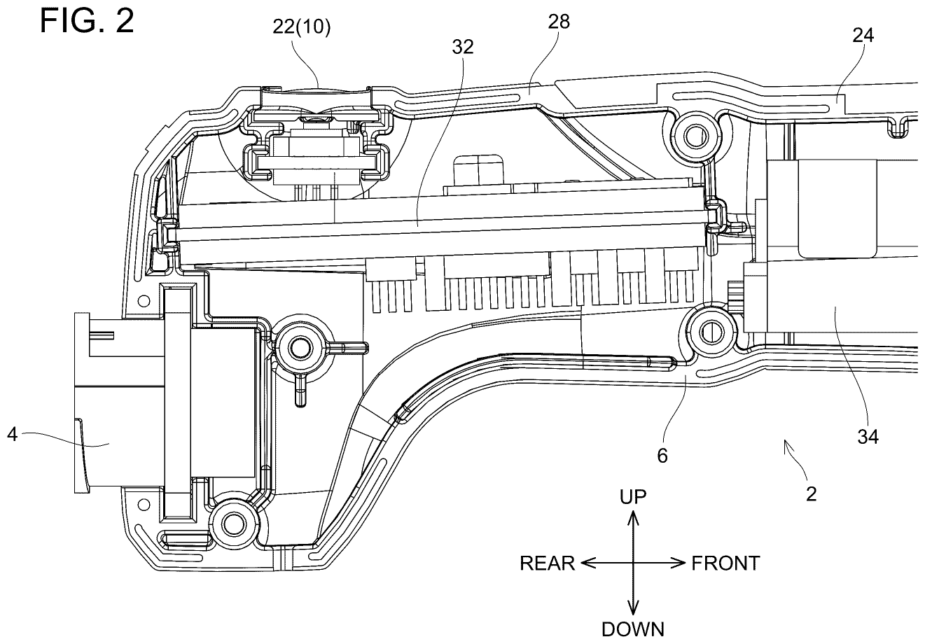

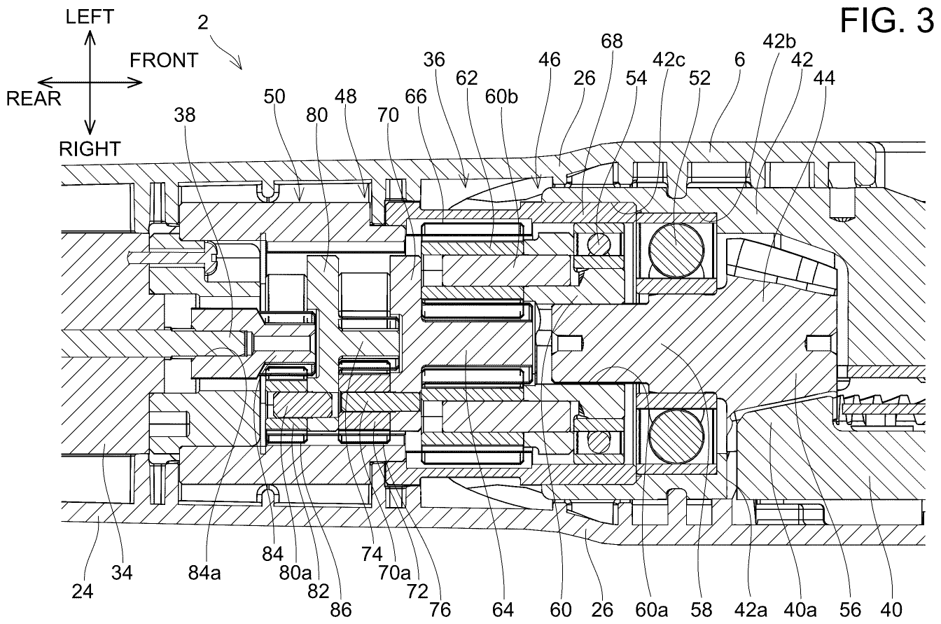

The working machine 2 further comprises a control device 32 (see FIG. 2), an electric motor 34 (see FIG. 2), and a power transmission 36 (see FIG. 3).

As shown in FIG. 2, the control device 32 is housed within the rear housing portion 28. The control device 32 is electrically connected to the power connector 4, the manipulatable part 10, the display part 12 (see FIG. 1), and the electric motor 34. The control device 32 comprises a power circuit (not shown) for adjusting electric power supplied through the power connector 4 and a control circuit (not shown) for controlling operations of the manipulatable part 10, the display part 12, and the electric motor 34. The electric power supplied from the external power supply through the power connector 4 is adjusted by the power circuit of the control device 32 and is then supplied to the manipulatable part 10, the display part 12, and the electric motor 34.

The electric motor 34 is, for example, a direct current brushless motor such as a coreless motor. The electric motor 34 is housed within the grip 24. An output shaft 38 (see FIG. 3) of the electric motor 34 extends along the front-rear direction.

As shown in FIG. 3, the power transmission 36 is housed within the front housing portion 26. The power transmission 36 comprises a gear piece 40, a gear housing 42, a bevel gear 44, a first planetary gear mechanism 46, a second planetary gear mechanism 48, a third planetary gear mechanism 50, a first bearing 52, and a second bearing 54. The gear housing 42 is fixed to the front housing portion 26. The bevel gear 44 is housed within the gear housing 42. The bevel gear 44 comprises a gear portion 56 and a shaft portion 58. The gear portion 56 is seamlessly integral with the shaft portion 58.

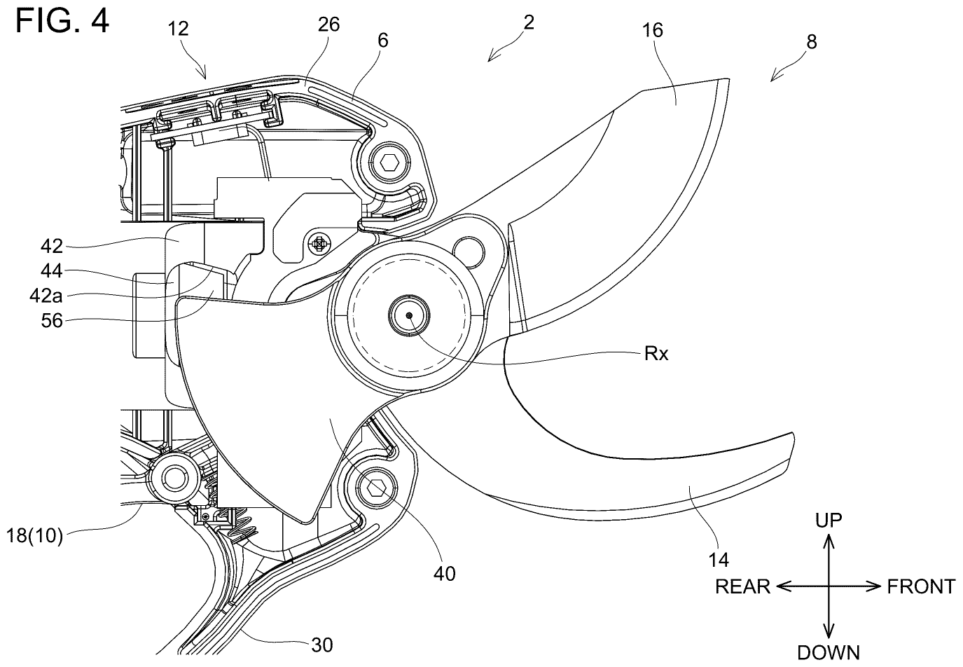

As shown in FIG. 4, an opening 42a is formed in the right surface of the gear housing 42. The gear portion 56 of the bevel gear 44 meshes, via the opening 42a, with a gear portion 40a (see FIG. 3) formed on the left surface of the gear piece 40. The gear piece 40 is fixed to the movable blade 16, and the gear piece 40 and the movable blade 16 integrally rotate about the rotation axis Rx. Thus, when the bevel gear 44 rotates clockwise in the front view, the gear piece 40 and the movable blade 16 rotate clockwise in the right side view (i.e., in a closing direction of the movable blade 16). Conversely, when the bevel gear 44 rotates counterclockwise in the front view, the gear piece 40 and the movable blade 16 rotate counterclockwise in the right side view (i.e., in an opening direction of the movable blade 16).

As shown in FIG. 3, a first bearing mounting portion 42b is formed on the gear housing 42. The first bearing 52 is mounted to the first bearing mounting portion 42b such that its center axis is along the front-rear direction. The shaft portion 58 of the bevel gear 44 is rotatably supported by the first bearing 52.

The first planetary gear mechanism 46 comprises a first carrier 60, a first planetary gear 62, a first sun gear 64, a first internal gear 66, and a cylindrical sleeve 68. At a position rearward of the first bearing 52, the shaft portion 58 of the bevel gear 44 is fitted in a fitting hole 60a formed in the first carrier 60. The bevel gear 44 and the first carrier 60 rotate integrally. The first carrier 60 supports the first planetary gear 62 via a pin 60b such that the first planetary gear 62 is rotatable. The first internal gear 66 is arranged outward of the first planetary gear 62 to mesh with the first planetary gear 62. The first sun gear 64 is arranged inward of the first planetary gear 62 to mesh with the first planetary gear 62. The first planetary gear mechanism 46 functions as a rotation reducer that reduces the rotation of the first sun gear 64 and transmits it to the first carrier 60.

The cylindrical sleeve 68 is located forward of the first internal gear 66. The cylindrical sleeve 68 is seamlessly integral with the first internal gear 66. The second bearing 54 is mounted to the cylindrical sleeve 68 such that its center axis is along the front-rear direction. The first carrier 60 is rotatably supported by the second bearing 54. A cylindrical sleeve mounting portion 42c having internal threads is formed on the inner surface of the gear housing 42. External threads corresponding to the internal threads of the cylindrical sleeve mounting portion 42c are formed in the outer surface of the cylindrical sleeve 68. The cylindrical sleeve 68 is fixed to the gear housing 42 by being screwed into the cylindrical sleeve mounting portion 42c. In the state where the cylindrical sleeve 68 is fixed to the gear housing 42, the front end of the cylindrical sleeve 68 is in contact with the rear end of the first bearing 52. Thus, the cylindrical sleeve 68 functions as a retainer that prevents the first bearing 52 from falling off from the gear housing 42.

The second planetary gear mechanism 48 comprises a second carrier 70, a second planetary gear 72, a second sun gear 74, and a second internal gear 76. The second carrier 70 is seamlessly integral with the first sun gear 64, and the second carrier 70 and the first sun gear 64 rotate integrally. The second carrier 70 supports the second planetary gear 72 via a pin 70a such that the second planetary gear 72 is rotatable. The second internal gear 76 is arranged outward of the second planetary gear 72 to mesh with the second planetary gear 72. The second sun gear 74 is arranged inward of the second planetary gear 72 to mesh with the second planetary gear 72. The second planetary gear mechanism 48 functions as a rotation reducer that reduces the rotation of the second sun gear 74 and transmits it to the second carrier 70.

The third planetary gear mechanism 50 comprises a third carrier 80, a third planetary gear 82, a third sun gear 84, and a third internal gear 86. The third carrier 80 is seamlessly integral with the second sun gear 74, and the third carrier 80 and the second sun gear 74 rotate integrally. The third carrier 80 supports the third planetary gear 82 via a pin 80a such that the third planetary gear 82 is rotatable. The third internal gear 86 is arranged outward of the third planetary gear 82 to mesh with the third planetary gear 82. The third sun gear 84 is arranged inward of the third planetary gear 82 to mesh with the third planetary gear 82. The third planetary gear mechanism 50 functions as a rotation reducer that reduces the rotation of the third sun gear 84 and transmits it to the third carrier 80. The second internal gear 76 is seamlessly integral with the third internal gear 86. The second internal gear 76 and the third internal gear 86 are fixed to the first internal gear 66 and the front housing portion 26.

The output shaft 38 of the electric motor 34 is fitted in a fitting hole 84a formed in the third sun gear 84, and the output shaft 38 and the third sun gear 84 rotate integrally. Thus, when the electric motor 34 is started, the rotation of the output shaft 38 is transmitted to the bevel gear 44 after reduced in each of the third planetary gear mechanism 50, the second planetary gear mechanism 48, and the first planetary gear mechanism 46, and then is transmitted to the movable blade 16 via the gear piece 40.

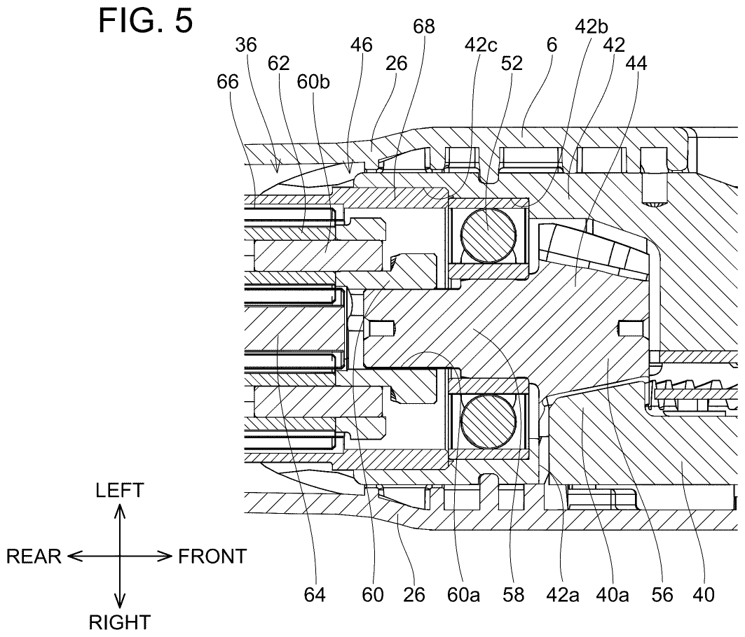

When the working machine 2 performs cutting work, a force is generated that presses the gear piece 40 against the gear portion 56 of the bevel gear 44 due to a reaction force the movable blade 16 receives from the cutting target object, and thus a leftward force is applied to the gear portion 56 of the bevel gear 44. As shown in FIG. 5, if the second bearing 54, which supports the first carrier 60 such that the first carrier 60 is rotatable, were absent, a portion of the shaft portion 58 of the bevel gear 44 that is located rearward of the first bearing 52 would be tilted rightward when the leftward force is applied to the gear portion 56 of the bevel gear 44. In this case, the first carrier 60 is displaced rightward, thereby causing the first planetary gear 62 to unevenly contact the first sun gear 64 and/or the first internal gear 66.

In contrast, as shown in FIG. 3, the working machine 2 according to this embodiment comprises the second bearing 54 supporting the first carrier 60 such that the first carrier 60 is rotatable. Thus, even when the leftward force is applied to the gear portion 56 of the bevel gear 44, the portion of the shaft portion 58 of the bevel gear 44 that is located rearward of the first bearing 52 is not tilted rightward since the second bearing 54 holds the first carrier 60 not to be displaced rightward. The first planetary gear 62 is thus prevented from unevenly contacting the first sun gear 64 and/or the first internal gear 66.

(Variants) In the embodiment described above, the working machine 2 is pruning shears and the working part 8 comprises the fixed blade 14 and the movable blade 16, which is merely an example. However, the working machine 2 may be a working machine of another type and the working part 8 may be a working part of another type. For example, the working machine 2 may be a cutter, a rivetter, a grinder, or the like.

The working machine 2 may comprise a battery pack mounting portion (not shown) to which a rechargeable battery pack (not shown) can be detachably attached, instead of the power connector 4.

The electric motor 34 may be replaced by a motor of another type (e.g., a motor with brush, a motor with core).

(Features of Embodiment) As described above, in one or more embodiments, the working machine 2 comprises the electric motor 34 (an example of prime mover), the power transmission 36 connected to the electric motor 34, the working part 8 connected to the power transmission 36, and the housing 6 that houses the power transmission 36. The power transmission 36 comprises the first planetary gear mechanism 46, the bevel gear 44, the first bearing 52, and the second bearing 54. The bevel gear 44 comprises the gear portion 56 connected to the working part 8 and the shaft portion 58 integrally rotatable with the gear portion 56. The first planetary gear mechanism 46 comprises the first carrier 60 integrally rotatable with the shaft portion 58, the first planetary gear 62 rotatably supported by the first carrier 60, the first internal gear 66 arranged outward of the first planetary gear 62 to mesh with the first planetary gear 62, and the first sun gear 64 arranged inward of the first planetary gear 62 to mesh with the first planetary gear 62. The first bearing 52 is directly or indirectly supported by the housing 6 and supports the shaft portion 58 such that the shaft portion 58 is rotatable. The second bearing 54 is directly or indirectly supported by the housing 6 and supports the first carrier 60 such that the first carrier 60 is rotatable.

In the configuration above, the second bearing 54 holds the first carrier 60 not to be displaced in a direction orthogonal to the rotation axis. Therefore, even when a force is applied to the gear portion 56 of the bevel gear 44 in a predetermined direction due to a reaction force the working part 8 receives from a workpiece, it is possible to prevent the shaft portion 58 of the bevel gear 44 from being tilted in the opposite direction to the predetermined direction with the first bearing 52 as a fulcrum point,. This configuration thus can prevent the first planetary gear 62 from unevenly contacting the first sun gear 64 and/or the first internal gear 66.

In one or more embodiments, the first internal gear 66 is fixed to the housing 6.

The configuration above allows the first planetary gear mechanism 46 to function as a rotation reducer with a large reduction ratio.

In one or more embodiments, the first planetary gear mechanism 46 further comprises the cylindrical sleeve 68 (an example of sleeve) formed integrally with the first internal gear 66. The second bearing 54 is directly supported by the cylindrical sleeve 68.

The configuration above allows for simplification of the support structure for the second bearing 54.

In one or more embodiments, the cylindrical sleeve 68 contacts the first bearing 52 in the direction of the central axis of the first bearing 52.

The configuration above allows the cylindrical sleeve 68, which is integrally formed with the first internal gear 66, to function as a retainer for the first bearing 52 and thus allows for simplification of the support structure for the first bearing 52.

In one or more embodiments, the power transmission 36 further comprises the second planetary gear mechanism 48. The second planetary gear mechanism 48 comprises the second carrier 70 integrally rotatable with the first sun gear 64, the second planetary gear 72 rotatably supported by the second carrier 70, the second internal gear 76 arranged outward of the second planetary gear 72 to mesh with the second planetary gear 72, and the second sun gear 74 arranged inward of the second planetary gear 72 to mesh with the second planetary gear 72.

The configuration above allows for a rotation reduction in each of the first planetary gear mechanism 46 and the second planetary gear mechanism 48.

In one or more embodiments, the second internal gear 76 is a separate component from the first internal gear 66.

The first planetary gear mechanism 46 and the second planetary gear mechanism 48 are different from each other in the rotating speed and torque inputted thereto, the reduction ratio to be achieved, etc., and thus the first internal gear 66 and the second internal gear 76 are different from each other in the required strength and rigidity. The above configuration allows the first internal gear 66 and the second internal gear 76 to be formed from suitable materials and suitably sized to achieve required strengths and rigidities since these internal gears are separate components.

In one or more embodiments, the working part 8 comprises the fixed blade 14 (an example of first blade) and the movable blade 16 (an example of second blade) movable relative to the fixed blade 14 between an open position and a closed position. The working machine 2 functions as handheld pruning shears.

The configuration above prevents the first planetary gear 62 from unevenly contacting the first sun gear 64 and/or the first internal gear 66 in the working machine 2 that functions as pruning shears.

In one or more embodiments, the prime mover of the working machine 2 is the electric motor 34.

The configuration above prevents the first planetary gear 62 from unevenly contacting the first sun gear 64 and/or the first internal gear 66 in the working machine 2 that actuates the working part 8 by the electric motor 34.

What is claimed is:

1. A working machine comprising:
a prime mover;
a power transmission connected to the prime mover;
a working part connected to the power transmission; and
a housing that houses the power transmission,
wherein
the power transmission comprises:
a first planetary gear mechanism;
a bevel gear;
a first bearing; and
a second bearing,
the bevel gear comprises:
a gear portion connected to the working part; and
a shaft portion integrally rotatable with the gear portion, the first planetary gear mechanism comprises:
a first carrier integrally rotatable with the shaft portion;
a first planetary gear rotatably supported by the first carrier;
a first internal gear arranged outward of the first planetary gear to mesh with the first planetary gear; and
a first sun gear arranged inward of the first planetary gear to mesh with the first planetary gear,
the first bearing is directly or indirectly supported by the housing and supports the shaft portion such that the shaft portion is rotatable, and
the second bearing is directly or indirectly supported by the housing and supports the first carrier such that the first carrier is rotatable.

2. The working machine according to claim 1, wherein the first internal gear is fixed to the housing.

3. The working machine according to claim 1, wherein
the first planetary gear mechanism further comprises a sleeve formed integrally with the first internal gear, and
the second bearing is directly supported by the sleeve.

4. The working machine according to claim 3, wherein the sleeve contacts the first bearing in a direction of a central axis of the first bearing.

5. The working machine according to claim 1, wherein
the power transmission further comprises a second planetary gear mechanism,
the second planetary gear mechanism comprises:
a second carrier integrally rotatable with the first sun gear;
a second planetary gear rotatably supported by the second carrier;
a second internal gear arranged outward of the second planetary gear to mesh with the second planetary gear; and
a second sun gear arranged inward of the second planetary gear to mesh with the second planetary gear.

6. The working machine according to claim 5, wherein the second internal gear is a separate component from the first internal gear.

7. The working machine according to claim 1, wherein
the working part comprises:
a first blade; and
a second blade movable relative to the first blade between an open position and a closed position, and
the working machine functions as handheld pruning shears.

8. The working machine according to claim 1, wherein the prime mover comprises an electric motor.

9. The working machine according to claim 2, wherein
the first planetary gear mechanism further comprises a sleeve formed integrally with the first internal gear,
the second bearing is directly supported by the sleeve,
the sleeve contacts the first bearing in a direction of a central axis of the first bearing,
the power transmission further comprises a second planetary gear mechanism,
the second planetary gear mechanism comprises:
a second carrier integrally rotatable with the first sun gear;
a second planetary gear rotatably supported by the second carrier;
a second internal gear arranged outward of the second planetary gear to mesh with the second planetary gear; and
a second sun gear arranged inward of the second planetary gear to mesh with the second planetary gear,
the second internal gear is a separate component from the first internal gear,
the working part comprises:
a first blade; and
a second blade movable relative to the first blade between an open position and a closed position,
the working machine functions as handheld pruning shears, and
the prime mover comprises an electric motor.
